(19) United States
(12) Patent Application Publication
(10) Pub. No.: US 2013/0132452 A1
(43) Pub. Date: May 23, 2013

(54) Method and Apparatus for Fast Computation of Integral and Fractional Parts of a High Precision Floating Point Multiplication Using Integer Arithmetic

(71) Applicants: Ravi Korsa, Bangalore (IN); Kalyan Kumar Jayappa Reddy, Bangalore (IN)

(72) Inventors: Ravi Korsa, Bangalore (IN); Kalyan Kumar Jayappa Reddy, Bangalore (IN)

(21) Appl. No.: 13/302,469

(22) Filed: Nov. 22, 2011

(51) Int. Cl. G06F 7/487

(52) U.S. Cl. 708/204; 708/503

(57) ABSTRACT

A system and method which multiplies the bits using integer multiplication is set forth. More specifically, performing a floating point operation using integer multiplication includes performing a high precision multiplication of an input ‘x’ having a first bit width using a plurality of integer multiplication operations of a second bit width, the second bit width being smaller than the first bit width, the plurality of integer multiplication operations each generating a result corresponding the first bit width.

### BACKGROUND OF THE INVENTION

1. Field of the Invention

The present invention relates in general to of processors, and more specifically, to a floating point unit (FPU) containing a variable speed execution pipeline.

2. Description of the Related Art

The desire for ever-faster computers makes it desirable for processors to execute instructions, including floating point type instructions, in a minimum amount of time. Processor speeds have been increased in a number of different ways, including increasing the speed of the clock that drives the processor, reducing the number of clock cycles required to perform a given instruction, implementing pipeline architectures, and increasing the efficiency at which internal operations are performed. This last approach usually involves reducing the number of steps required to perform an internal operation.

One example of a function which can require multiple steps is a Trigonometric function. Trigonometric functions require an input argument to be within [−pi/4 pi/4]. For example, given an input argument ‘x’ we need to find ‘k’ and ‘r’ such that

x=k*(pi/2)+r where ‘k’ is an integer and |r|≦pi/4

if y=x*(2/pi) then k=[y] and

if f=y−k then r=f*(pi/2)

However, these calculations cannot be directly computed as they can lead to an undesirable accuracy loss. It is known that it may be required to store a total of 1144 bits of (2/pi) and to compute ‘y’ with approximately 180 contiguous bits of (2/pi) since the least significant two bits of ‘k’ are needed. One possible method to multiply the two double operands is to perform an IEEE standard double multiplication. However, this operation can lead to loss of accuracy and the number of multiplications required to multiply a multi-precision number will be more in number.

### SUMMARY OF EMBODIMENTS

In accordance with one embodiment of the present invention, a system and method is set forth which multiplies the bits using integer multiplication. More specifically, a high precision multiplication of ‘x’ with 180 bits of 2/pi is performed using three 64-bit integer multiplications each of which gives a 128-bit result.

In certain embodiments, the invention further includes a novel method for aligning the bits to be multiplied in the memory. Loads and stores in x86 architecture are faster when the data starts at an address which is a multiple of 16 and is contiguous in memory. Because the 1200 bits of 2/pi are stored starting at a 16-byte aligned address and are contiguous in memory, this optimization is provided. Due to this, the number of loads to fetch the bits to be multiplied is minimized For example in certain embodiments, the 1200 bits of 2/pi are stored in groups of 8 bits (i.e., a byte) contiguously in an array in reverse order. More specifically, the data is stored in reverse order so that the least significant bits can be multiplied first and the contiguousness is desirable for the loads to be faster. This array may be referred to as a two_by_pi bits array.

More specifically, in one embodiment, the invention relates to a method for performing a floating point operation using integer multiplication. The method includes performing a high precision multiplication of an input ‘x’ having a first bit width using a plurality of integer multiplication operations of a second bit width, the second bit width being smaller than the first bit width, the plurality of integer multiplication operations each generating a result corresponding the first bit width.

In another embodiment, the invention relates to an apparatus for performing a floating point operation using integer multiplication. The apparatus includes means for performing a high precision multiplication of an input ‘x’ having a first bit width using a plurality of integer multiplication operations of a second bit width, the second bit width being smaller than the first bit width, the plurality of integer multiplication operations each generating a result corresponding the first bit width.

In another embodiment, the invention relates to a processor which includes a floating point unit. The floating point unit includes instructions executable by the floating point unit for performing a high precision multiplication of an input ‘x’ having a first bit width using a plurality of integer multiplication operations of a second bit width, the second bit width being smaller than the first bit width, the plurality of integer multiplication operations each generating a result corresponding to the first bit width.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows an exemplary data processor in which a floating point unit is implemented.

FIG. 2 shows a block diagram of an arrangement of bits when performing an alignment operation.

FIG. 3 shows a flow chart of the floating point operation using a variable speed execution pipeline.

FIG. 4 shows a flow chart of the operation of a multiplication operation.

### DETAILED DESCRIPTION

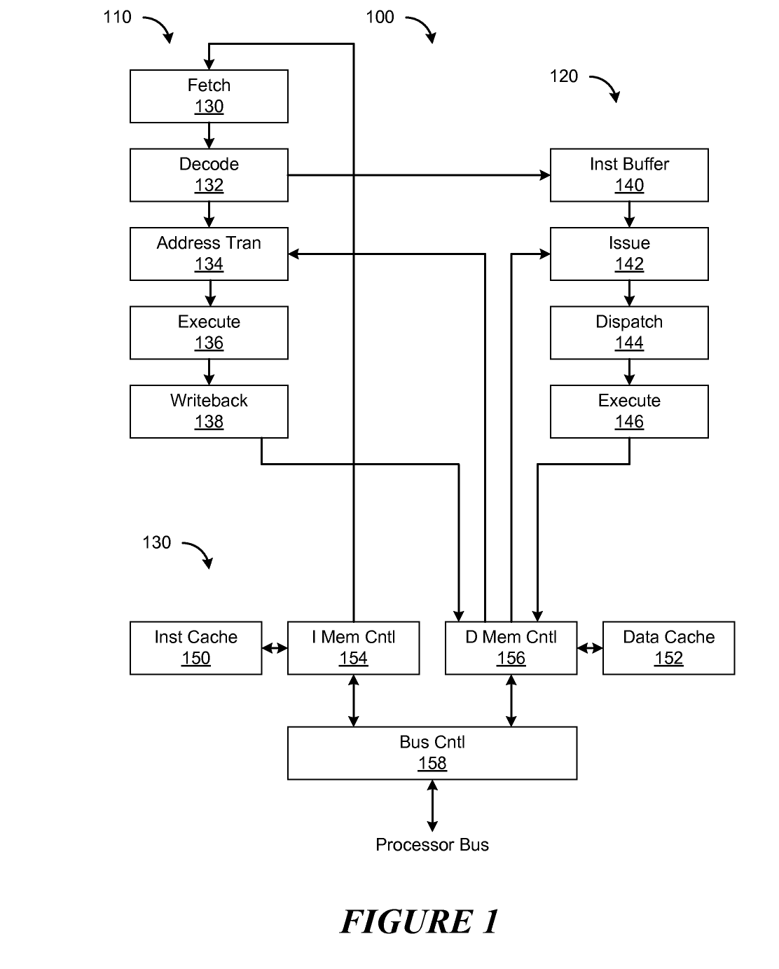

Referring to FIG. 1, an exemplary processor 100 is shown. The processor could be implemented as a central processing unit (CPU), a graphics processing unit (GPU), an accelerated processing unit (APU), a digital signal processor, and the like. In the illustrated embodiment, the processor 100 includes an integer unit (IU) 110, a floating point unit (FPU) 120, and memory unit (MU) 130. The integer unit 110 includes an instruction fetch unit 130, an instruction decode unit 132, an address translation unit 134, an integer execution pipeline 136, and a writeback unit 138. The floating point unit (FPU) 120 includes an instruction buffer 140, an issue unit 142, a dispatch unit 144, and a floating point unit (FPU) execution pipeline 146. The memory unit 130 includes an instruction cache 150, a data cache 152, an instruction memory controller 154, a data memory controller 156, and a bus controller 158.

The data processing system implements a system and method which multiplies the bits using integer multiplication. More specifically, with the data processing system 100, a high precision multiplication of ‘x’ with 180 bits of 2/pi is performed using three 64-bit integer multiplications each of which gives a 128-bit result.

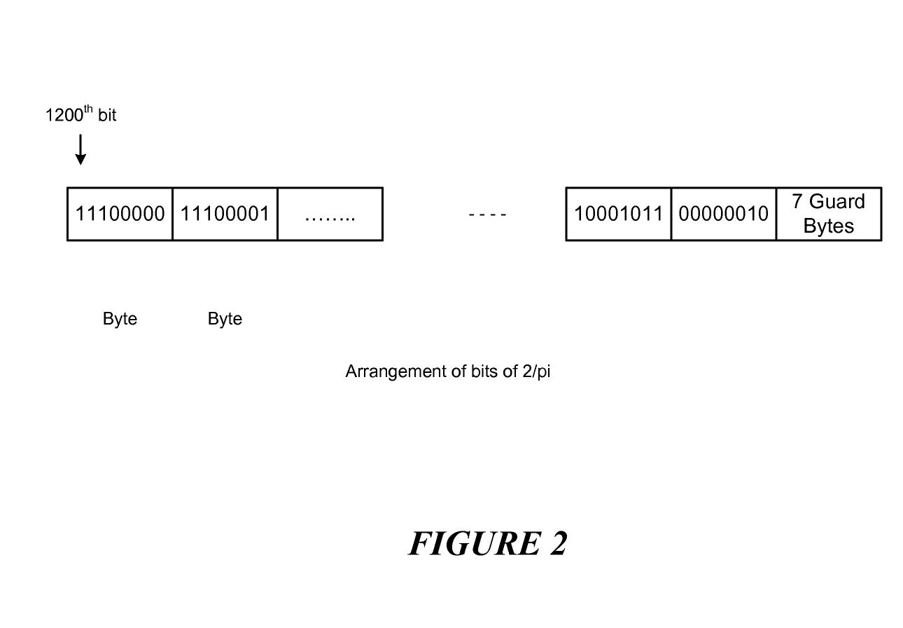

In certain embodiments, the data processing system 100 further implements a method for aligning the bits to be multiplied in the memory such that optimization is considered. A number of loads to fetch the bits to be multiplied is minimized. For example in certain embodiments, the 1200 bits of 2/pi are stored in groups of 8 bits (byte) contiguously in an array in reverse order. This array may be referred to as two_by_pi bits. FIG. 2 shows a block diagram of an arrangement of bits when performing an alignment operation.

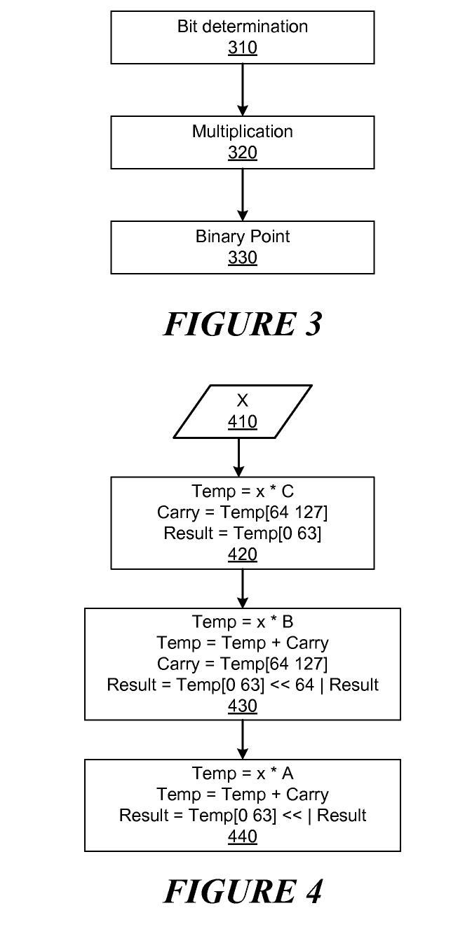

FIG. 3 shows a flow chart of the floating point operation using a variable speed execution pipeline. More specifically, the operation starts by determining which bits are to be used for the floating point operation at step 310. Next, at step 320, the operation continues by performing a multiplication operation on the identified bits. Next, at step 330, the operation continues by determining a binary point (i.e., the radix point) of the bits.

More specifically, when performing the bit determination operation 310, for a given input argument ‘x’, the index, ‘last’ into two_by_pi bits is calculated as shown below, from which 180 bits may be required. The following operations provide the index ‘last’ based on the exponent of ‘x.’

by_{—}8=xexp>>3; //xexp=x's unbiased exponent

first=157−by_{—}8; //157=total number of bytes for 1200 bits of (2/pi)+7 guard bytes

last=first−23;// 24 bytes (192 bits) of (2/pi) between first and last

where ‘last’ is the index into two_by_pi bits from which to take 180 bits of (2/pi). Because 64-bit integer multiplications with 128-bit outputs are available on x86-64 bit processors, considering 192 bits of (2/pi) for multiplication instead of 180, provides higher accuracy in the final reduced argument at no extra cost. 192 bits of (2/pi) are loaded using 2 loads (one 128-bit load and one 64-bit load).

FIG. 4 shows a flow chart of the operation of a multiplication operation. More specifically, the multiplication operation 320 of the bits (x*2/pi) is performed using a MUL instruction. With the MUL instruction, the integer multiply instruction in x86-64 multiplies a 64-bit register or memory operand by the contents of a RAX-register and stores the result (128 bit) in the RDX:RAX register. The present invention uses this instruction to reduce the number of multiplications to be performed to provide a multi-precision result.

The input ‘x’ is treated as an integer where the sign and exponent components of the integer are zeroed out at step 410. The integer further includes the implied bit at bit position 52 to provide a total of 53 bits of ‘x’. The 192 bits of 2/pi are in three-64-bit registers A, B and C, with C having the least significant bits followed by B and then A. Each multiplication of ‘x’ with A,B or C can produce only a-maximum of 64+53=117 bits. The three multiplications are carried out as follows.

At step 420, x*C is calculated. The higher 64 bits are carried and the lower 64 bits are preserved into result.

At step 430, x*B+Carry: X*B results into max of 53+64 bits. The carry from the previous multiplication is added to provide accurate results. But there is no instruction which performs a 128 bit addition in x86-64 system. This issue is resolved by adding the carry to lower order results and doing a ‘adc’ (add with carry) with zero for the higher order results. The lower 64 bits are preserved into results and the higher order bits are carried.

At step 440, x*A+Carry is calculated by repeating the same operation.

The result bits=(X*A)#(X*B)#(X*C).

Next, when performing the determine binary point operation 330, further calculations are performed to determine the binary point and also adjust the result if the bit right after the binary point is set. The binary point is determined based on the following formula:

resexp=xexp−(by_{—}8<<3);

int_bits=10−resexp; //int_bits=number of bits before binary point
int_bits provides the number of bits before the binary point and the rest of the bits determine ‘f’. Further calculations are performed to compute the reduced argument.

Although the present invention has been described in detail, it should be understood that various changes, substitutions and alterations can be made hereto without departing from the spirit and scope of the invention as defined by the appended claims.

For example, the present invention can be applied to any high-precision floating point multiplication where high accuracy is required, specifically in the area of scientific computations and HPC. Any high precision number may be used in place of 2/pi which may require this computation. The preferred embodiment computes only a few integral bits, but the method can be used to compute the entire integral bits and any number of fractional bits of the resulting floating point number.

Also for example, the described method may be implemented by using an integer fused multiply-add rather than using two instructions ‘mul’ and ‘adc’; by using 256 bit loads as in AVX instruction instead of two loads to load 192 bits of 2/pi; by using SIMD integer multiplication which can produce 128-bit results (such a method may require only one multiplication instead of three); by using faster register to register bit transfers or by using bit shifts on a 128-bit or higher registers; and/or configuring all three multiplications of ‘x’ with A, B, and C independently so the multiplications can be clubbed into a single integer SIMD multiplication.

In some embodiments, program instructions (such as those used to implement the described method) may be provided as an article of manufacture that may include a computer-readable storage medium having stored thereon instructions that may be used to program a computer system (or other electronic devices) to perform a process according to various embodiments. A computer-readable storage medium may include any mechanism for storing information in a form (e.g., software, processing application) readable by a machine (e.g., a computer). The machine-readable storage medium may include, but is not limited to, magnetic storage medium (e.g., disk); optical storage medium (e.g., CD-ROM); magneto-optical storage medium; read only memory (ROM); random access memory (RAM); erasable programmable memory (e.g., EPROM and EEPROM); flash memory; electrical, or other types of tangible medium suitable for storing program instructions.

Additionally, some embodiments can be fabricated using well known techniques that can be implemented with a data processing system using code (e.g., Verilog, Hardware Description Language (HDL) code, etc.) stored on a computer usable medium. The code comprises data representations of the circuitry and components described herein that can be used to generate appropriate mask works for use in well known manufacturing systems to fabricate integrated circuits embodying aspects of the invention.

What is claimed is:

1. A method for performing a floating point operation using integer multiplication comprising:
performing, via a processor, a high precision multiplication of an input ‘x’ having a first bit width using a plurality of integer multiplication operations of a second bit width, the second bit width being smaller than the first bit width, the plurality of integer multiplication operations each generating a result corresponding the first bit width.

2. The method of claim 1 wherein:
the input ‘x’ is multiplied by a value of 2/pi.

3. The method of claim 2 further comprising:
aligning the bits to be multiplied such that optimization is considered.

4. The method of claim 1 further comprising:
calculating a binary point of the input ‘x.’

5. The method of claim 2 wherein:
the value of 2/pi is stored as a plurality of groups of bits, the plurality of groups of bits being contiguously stored in an array in reverse order.

6. The method of claim 5 wherein:
each of the plurality of groups of bits corresponds to a byte.

7. An apparatus for performing a floating point operation using integer multiplication comprising:
means for performing a high precision multiplication of an input ‘x’ having a first bit width using a plurality of integer multiplication operations of a second bit width, the second bit width being smaller than the first bit width, the plurality of integer multiplication operations each generating a result corresponding the first bit width.

8. The apparatus of claim 7 wherein:
the input ‘x’ is multiplied by a value of 2/pi.

9. The apparatus of claim 8 further comprising:
means for aligning the bits to be multiplied such that optimization is considered.

10. The apparatus of claim 7 further comprising:
means for calculating a binary point of the input ‘x.’

11. The apparatus of claim 7 wherein:
the value of 2/pi is stored as a plurality of groups of bits, the plurality of groups of bits being contiguously stored in an array in reverse order.

12. The apparatus of claim 11 wherein:
each of the plurality of groups of bits corresponds to a byte.

13. A processor comprising:
a floating point unit, the floating point unit configured to execute one or more instructions to:
perform a high precision multiplication of an input ‘x’ having a first bit width using a plurality of integer multiplication operations of a second bit width, the second bit width being smaller than the first bit width, the plurality of integer multiplication operations each generating a result corresponding to the first bit width.

14. The processor of claim 13 wherein:
the input ‘x’ is multiplied by a value of 2/pi.

15. The processor of claim 14 wherein the floating point unit further comprises instruction for:
aligning the bits to be multiplied such that optimization is considered.

16. The processor of claim 14 wherein the floating point unit further comprises instruction for:
calculating a binary point of the input ‘x.’

17. The processor of claim 14 wherein:
the value of 2/pi is stored as a plurality of groups of bits, the plurality of groups of bits being contiguously stored in an array in reverse order.

18. The processor of claim 17 wherein:
each of the plurality of groups of bits corresponds to a byte.
